(19) United States
(12) Patent Application Publication
(10) Pub. No.: US 2014/0241525 A1
(43) Pub. Date: Aug. 28, 2014

(54) RANDOM NUMBER GENERATOR BASED WIRELESS TRANSMISSION ENCODING CONTROL METHODOLOGY

(71) Applicant: David Deak, Ronkonkoma, NY (US)

(72) Inventor: David Deak, Ronkonkoma, NY (US)

(21) Appl. No.: 13/775,127

(22) Filed: Feb. 23, 2013

(51) Int. Cl. H04L 9/08

(52) U.S. Cl. CPC H04L 9/0816
USPC 380/46

(57) ABSTRACT

The present invention relates to an algorithm methodology control means for creating esoteric unique encrypted key coding generation, by a random number generator means, for wireless transmitter and receiver communications pairing and identification.

### SUMMARY OF THE INVENTION

The present invention teaches systematic advantages over prior art and relates to methods of encoding and decoding systems in general, and more specific to the encoding and decoding of wireless transmission and reception of data that are utilized in address matching of specific wireless transmitters and wireless receivers, but not limited to wireless systems per se.

Wireless transmitter encoding and wireless receiver decoding established to make said transmitter and receiver be in wireless communication, as exists functional from prior art, is categorized by simple “hard-wired-in” circuit techniques, DIP (Dual Inline Package) switching, or an algorithm to create a serial number that is transferred as firmware within a transmitter and receiver system. With prior art, in a case of an algorithm, that is first written on an external computer and then executed to insert a unique serial number in said transmitter and also in said receiver a unique serial number is created and stored in a transmitter and receiver system during the process of manufacturing in order that said system is matched with the same operational serial number used as a key code that distinguishes a particular transmitter and receiver system set, against all other key codes generated in past. The simplest form would be of the [n] number and [n+1] number sequencing to avoid repetition in paring key code numbers. Thus the task of firstly writing an algorithm to create a serial number and then physically via some electrical connexion wiring or cable connexion like a USB connector, involves a goodly amount of time during a production process to enter a new code for every transmitter system and paired receiver system and then some form of recording what was entered so as not to repeat a key code number; costing more time, record keeping, and rate of production.

One aspect of the present invention is to eliminate the above mentioned labourous task of prior art and maximizing production of “ready for shipment” tested units, by utilizing a prewritten method means of instantly generating a unique key code and internal to a transmitter unit and generated instantly upon an initial switch command procedure.

Another aspect of the present invention is to accomplish what prior has failed to do by utilizing a random number generator in a programme that is installed as firmware in a transmitter unit and a number storage subset of firmware installed in a paired receiver unit.

Another aspect of the present invention generates a random key code in said transmitter and after said key code generation in said transmitter is completed, the random number generator subset algorithm is disabled and said generated key code is stored in non-volatile memory and utilized for all future transmissions.

Another aspect of the present invention is for said generated key code once transmitted, to be accepted by an initially codeless receiver selected as a potential pairing member, and after said key code is received it is stored in non-volatile memory in said receiver and said non-volatile memory has the capability of storing a plurality of key codes sent by any other transmitter unit selected as a paring member.

Another aspect of the present invention is for sending a valid set of instructions to a paired receiver after said key code is initially generated and thereafter in future for all additional future transmissions.

Another aspect of the present invention algorithm is to instruct said transmitter to send a valid ON or OFF signal to turn ON or OFF a paired receiver.

Another aspect of the present invention algorithm is to instruct said transmitter to send a valid analogue to digital processed signal from a potentiometer setting or a plurality of settings for any purpose to a paired receiver to be utilized for any purpose; and to store said analogue processed signal information in either a volatile or non-so volatile memory bank for any future purpose in said receiver.

Another aspect of the present invention algorithm is to instruct said transmitter to send a valid analogue to digital processed signal from any analogue or digital device in communication with said transmitter or a plurality of analogue or digital devices for any purpose to a paired receiver to be utilized for any purpose; and to store said analogue to digital or digital to analogue processed signal information in either a volatile or non-volatile memory bank for any future purpose in said receiver.

Another aspect of the present invention is to utilize an auxiliary logic least significant bit to instantly and temporarily change said random number generated key code to advance from [n] to [n+1] thus producing a new temporary utility key code to control a device in said paired receiver.

Another aspect of the present invention is to utilize an auxiliary logic subset of a plurality of bits to instantly and temporarily change said random number generated key code to advance from [n] to [n+1] or [n+2] or [n+x] thus producing a new temporary utility key code or a plurality of codes to control a plurality of devices in said paired receiver or a plurality of receivers.

Another aspect of the present invention is for said transmitter to send a signal to a paired receiver to store a plurality of temporary utility key codes and further to be able to store a plurality of temporary utility key codes and further be able to change said temporary utility key codes or modify or erase and replace said temporary utility key codes within in said paired receiver or plurality of receivers.

### BRIEF DESCRIPTION OF THE DRAWINGS

FIG. 1 shows a flow chart for an algorithm of an ISM Band battery-less and wireless no transmitter configuration and method of transmission of data generation that produces single random number generated key code, an ON/OFF signal, and a pre-fixed user selected before transmission dimming value to be transmitted.

FIG. 2 shows a flow chart for an algorithm of a paired ISM Band receiver that is the completed signal path for a wireless electrical switch system with a pre-fixed user selected dimming feature.

FIG. 3 shows a flow chart for an algorithm of an ISM Band battery-less and wireless transmitter configuration and method of transmission of data generation that produces single random number generated key code, an ON/OFF signal, and an AUTO DIM selection that adds a MSB (Most Significant Bit) to said key code that changes said key code utilized as a trigger action for generating undulating dimming levels to be selected by a user.

FIG. 4 shows a flow chart for an algorithm of a paired ISM Band receiver that is the completed signal path for a wireless electrical switch system with an undulating dimming level feature that is user selected.

### DETAILED DESCRIPTION OF THE PREFERRED EMBODIMENTS

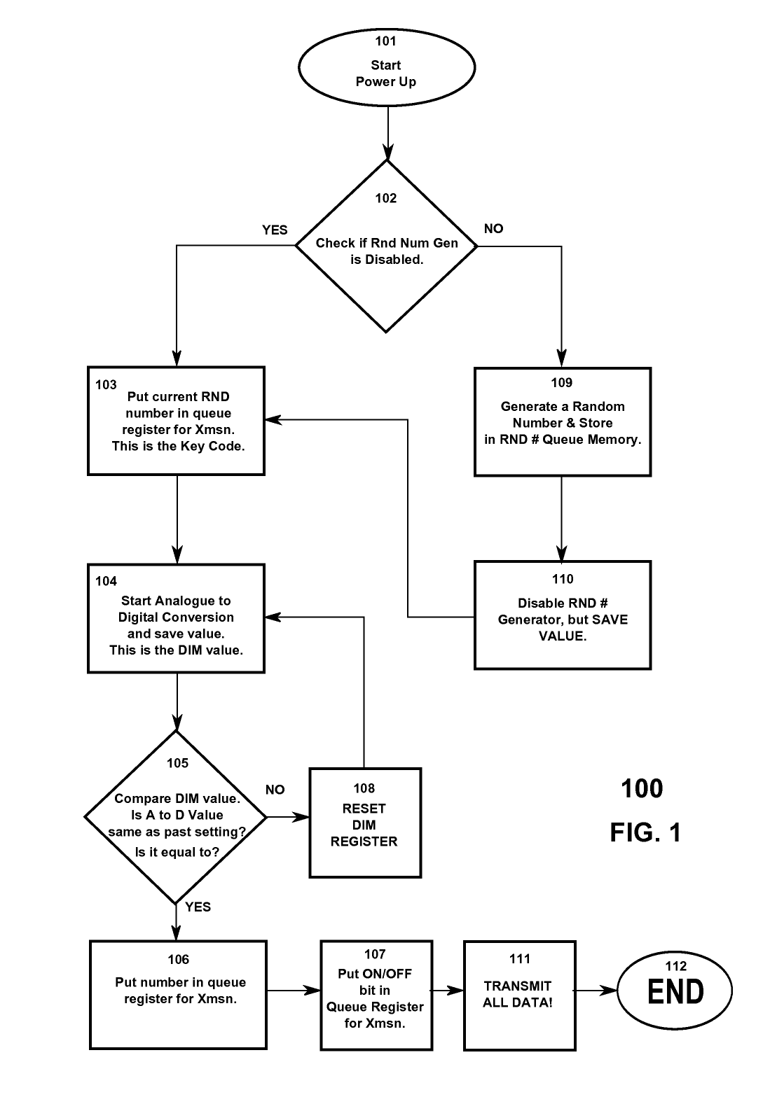

A flow chart 100 as seen in FIG. 1 shows the algorithm for a battery-less and wireless ISM Frequency Band transmitter like that was invented and produced by a New York (Long Island) company called ISM ENIGMA. LLC. Said details the firmware operation of said complete algorithm that does the following:

Initially when a transmitter from production is unboxed by a user, upon the first flick of the transmitter flip tab control method means, but not limited to a flip tab method means, which is disposed in said switch embodiment, electrical power is generated and stored to operate a microcontroller based ISM Band transmitter chip. Also the power up start command 101, initiates embedded firmware whose instruction set firstly checks to see if a random number generated key code has previously been generated 102, if not then it generates a unique key code by a random number generator and stores this in non-volatile memory 109. The second initial co-function is to disable said key code random number generator subset 110 and places the random number generated in queue for data transmission 103. Next in sequence analogue to digital conversion is started to convert an analogue DC voltage level (0 to 5 volts as example) to a digital number that exists as a light dimming level to be transmitted 104. Further said DIM value is compared to a previous DIM setting 105 and if it is not it is reset 108. If said DIM value is the same as a previous setting that value is placed in a transmission queue register for transmission 106. Said ON/OFF bit is set in register in said queue register for transmission 107. Consequently all data is then sent as a transmission data packet 111 and programme stops 112.

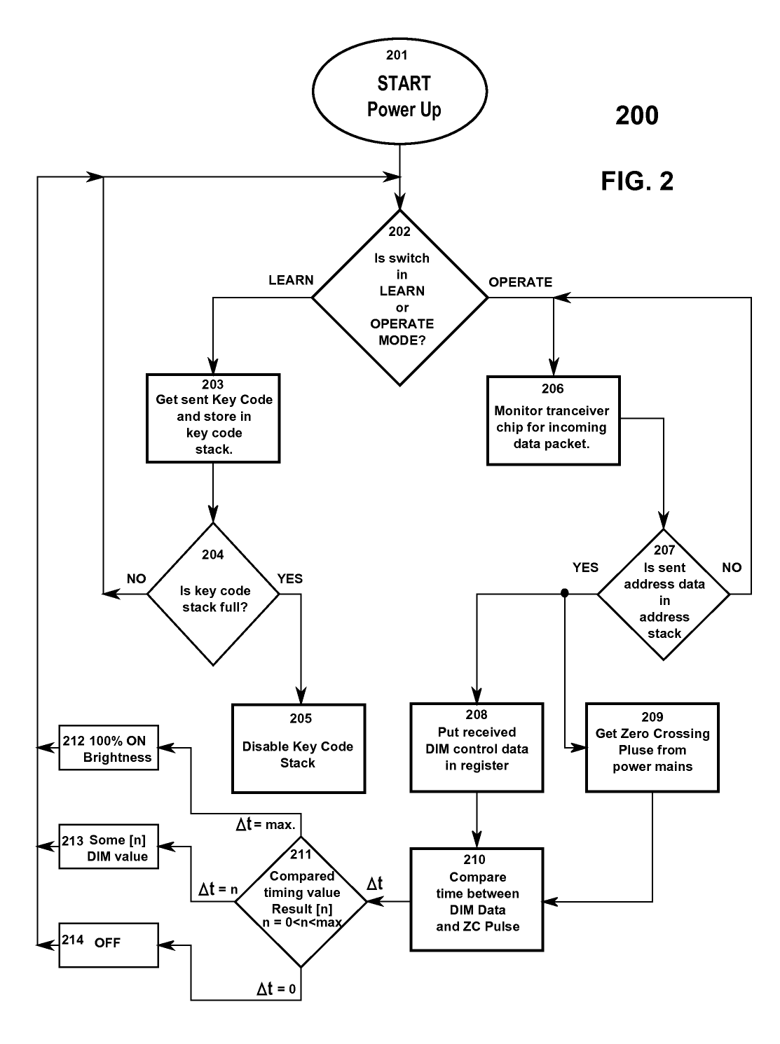

A flow chart 200 as shown in FIG. 2 shows the algorithm for a receiver that is paired with said transmitter algorithm of flow chart 100 in FIG. 1. With the transmitter, the programme is run only during a flip of a disposed energy harvesting generator within said battery-less and wireless electrical switch with said dimming feature. However with said receiver, the device means is connected to the power mains and has constant and continuous electrical power supplied to it. The operation and function of said receiver algorithm or programme in flow chart 200 has a power wake up and system start 201. In order for the receiver to be transmitter key code address paired to a transmitter in question, a LEARN/OPERATE push button switch controlled by a user to initiate the storing of said transmitter key code address and the algorithm checks to determine what operational mode said push button is in 202. IF said push button switch is in said LEARN mode then said key code is stored in a key code stack memory for future use 203 and there is stack memory room for a plurality of key code addresses. Next, said key code stack is checked to see if it has reached it capacity for said plurality of key codes previous 204. IF key code stack is NOT full, then the algorithm goes back to monitor said mode of LEARN/OPERATE push button switch 202. IF key code stack IS full, then said key code stack is disabled from accepting any more key codes 205. When said push button LEARN/OPERATE switch is in OPERATE mode, the algorithm continuously monitors the receiver for incoming data packets 206. Then said algorithm interrogates the key code stack, and determines if said incoming data packet is a valid key code address 207. IF said incoming key code is NOT in stack, it continues to monitor any incoming data packets 206. IF said incoming key code IS in stack, THEN put received DIM control data in DIM register 208 AND also get zero crossing pulse from power mains sampling 209. THEN said DIM value determines to period of an internal timer on a microcontroller and compares this time to a zero crossing of said power mains sample pulse 210 and this determines what a triac conduction duty cycle of the alternating current is and this controls said dimming value for a light or some other electrical load 211, IF said compared timing is ZERO value, THEN light or other electrical load is “OFF” 214. IF said compared timing is MAXIMUM value, THEN said light or other electrical load is “ON” 100% 212. IF said compared timing value lies between ZERO and MAXIMUM, THEN this is some DIM value less than 100% and more than 0% 213. Said algorithm THEN in any timing value situation goes back to interrogating said LEARN/OPERATE push button switch 202. This algorithm is a continuous monitoring and reporting programme.

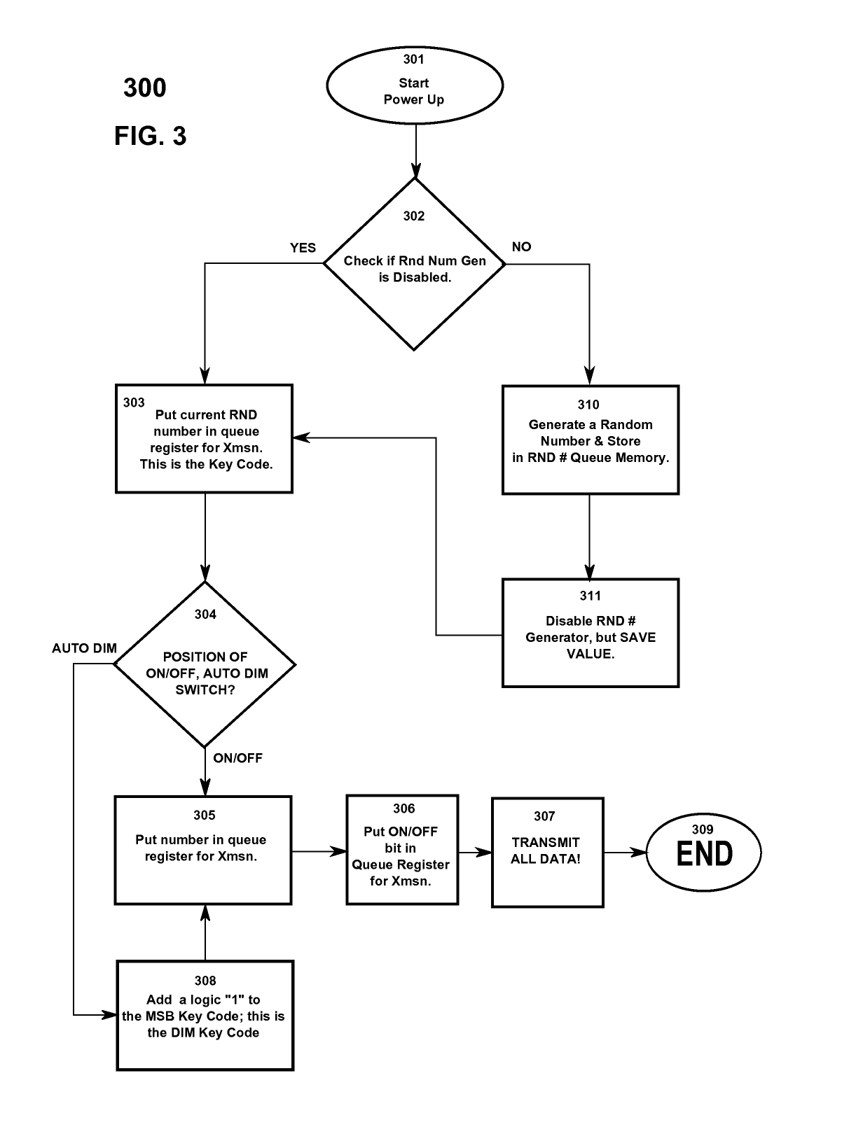

Another flow chart 300 as shown in FIG. 3 is that of another transmitter algorithm for a derivation on a dimming type of battery-less and wireless electrical switch with an AUTO DIM feature. Initially when a transmitter from production is unboxed by a user, upon the first flick of the transmitter flip tab control method means, but not limited to a flip tab method means, which is disposed in said switch embodiment, electrical power is generated and stored to operate a microcontroller based ISM Band transmitter chip. Also the power up start command 301, initiates embedded firmware whose instruction set firstly checks to see if a random number generated key code has previously been generated 302, if not then it generates a unique random number generated key code by a random number generator and stores this in non-volatile memory 310. The second initial co-function is to disable said key code random number generator subset 310 and places the random number generated in queue for data transmission 303. THEN the mode position of an ON/OFF/AUTO DIM selector switch disposed within said battery-less and wireless electrical switch with an auto dimming feature is interrogated and IF it is in said ON/OFF mode position said random number generated key code is put into a queue register for transmission 305 and then put ON/OFF bit in queue register for transmission 306 and then transmit all data 307 and END programme 309. IF ON/OFF/AUTO DIM selector switch is in AUTO DIM mode position THEN ADD a logic “1” to the unused MSB (Most Significant Bit) of the random number generated key code and this new key code number now represents a DIM value 308 to eventually be detected and utilized by a paired receiver for auto dimming sequencing, and this number is put into queue register for transmission 305 and all data is transmitted 307 and END programme 309.

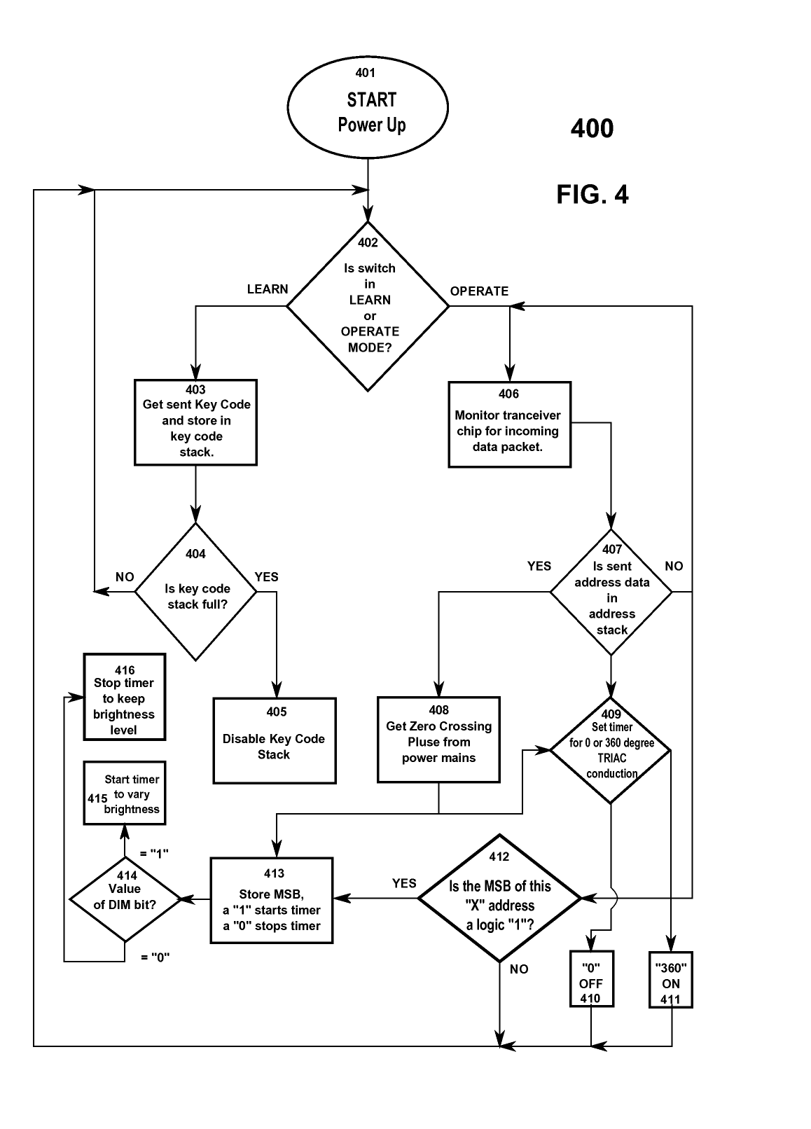

A flow chart 400 as shown in FIG. 4 shows the algorithm for a receiver that is paired with said transmitter algorithm of flow chart 200 in FIG. 2. With the transmitter, the programme is run only during a flip of a disposed energy harvesting generator within said battery-less and wireless electrical switch with said dimming feature. However with said receiver, the device means is connected to the power mains and has constant and continuous electrical power supplied to it. The operation and function of said receiver algorithm or programme in flow chart 400 has a power wake up and system start 401. In order for the receiver to be transmitter key code address paired to a transmitter in question, a LEARN/OPERATE push button switch controlled by a user to initiate the storing of said transmitter key code address and the algorithm checks to determine what operational mode said push button is in 402. IF said push button switch is in said LEARN mode then said key code is stored in a key code stack memory for future use 403 and there is stack memory room for a plurality of key code addresses. Next, said key code stack is checked to see if it has reached it capacity for said plurality of key codes previous 404. IF key code stack is NOT full, then the algorithm goes back to monitor said mode of LEARN/OPERATE push button switch 402. IF key code stack IS full, then said key code stack is disabled from accepting any more key codes 405. When said push button LEARN/OPERATE switch is in OPERATE mode, the algorithm continuously monitors the receiver for incoming data packets 406. Then said algorithm interrogates the key code stack, and determines if said incoming data packet is a valid key code address 407. IF said incoming key code is NOT in stack, it continues to monitor any incoming data packets 406. IF said key code is in said stack THEN a zero crossing pulse is recognized 408 for use in said auto dimming. Also an internal microcontroller timer is set for 0 to 360 degree (of the electrical cycle) TRIAC conduction in receiver 409. Said zero crossing signal pulse is compared to said conduction timer and if said result is “0” then the light or other electrical load is OFF 410. IF said conduction timer result is “360” then said light or other electrical load is ON 411. Also IF at the stack decision 407 the key code is not in said stack and IF it is a logic “1” THEN the decision 412 to store the MSB and a timer is started 413. IF the logic MSB is a logic “0” THEN the algorithm goes back to interrogate the LEARN/OPERATE switch 402. An additional flick of remote paired transmitter energy harvesting generator disposed within said paired transmitter creates the action of dumping in another MSB logic “1” that shifts to “0” and then stops timer 413. The timer bit is compared and if the value of the DIM timer bit is logic “0,” THEN stop DIM timer to keep brightness level 416. If accumulated timer bit is compared and IF it is logic “1,” THEN start DIM timer to create a brightness level 415.

### CLAIMS

An embodiment is an implementation or example of said invention. Reference in the specification to “an embodiment,” “one embodiment,” “some embodiments,” or “other embodiments” means that a particular feature, structure, or characteristic described in connection with the embodiments is included in at least some embodiments, but not necessarily all embodiments of said present invention. The various appearances of “an embodiment,” “one embodiment,” or “some embodiments” are not necessarily all referring to the same embodiments.

If the specification states a component, feature, structure, or characteristic “may,” “might,” or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Said present invention is not restricted to the particular details described herein. Indeed, many other variations of the foregoing description and drawings may be made within the scope of said present invention. Accordingly, it is the following claims including any amendments thereto that define the scope of said present invention.

What is claimed is:

1. A plurality of logic algorithms comprising:
a set of algorithms for utilization in a battery-less and wireless transmitter and remote receiver system that is paired together and matches to a specific internally generated random number key code or plurality of key codes, but not limited to a random number generated key code or plurality of key codes, and can be paired and matched by other forms of key code or plurality of key codes generation;
and whereby said key code that is generated by said transmitter algorithms is stored for any future use;
and when said key code or plurality of key codes are generated, said key code generator will be disabled from generating any future key codes that would be evaluated as an interference with said uniqueness of said specific generated key code or plurality of key codes;
and whereby said set of algorithms also generates an ON and OFF switch code that is utilized by both said battery-less and wireless, but not limited to a battery-less, transmitter system and paired receiver system for an electrical load power on and power off switching;
and said ON and OFF switch code is transmitted from said battery-less and wireless, but not limited to a battery-less, transmitter system to said receiver system;
and whereby said set of algorithms also generates a digital value dimming intensity level to be sent to said paired receiver system from said battery-less and wireless, but not limited to a battery-less, transmitter system;
and whereby said dimming digital value is generated by an analogue-to-digital method means;
and wherein said analogue-to-digital method means converts an analogue level from an analogue voltage potentiometer device means;
and wherein said analogue voltage means is internally converted in said microcontroller of said battery-less and wireless, but not limited to a battery-less, transmitter means to a digital intensity level that is sent by said battery-less and wireless, but not limited to a battery-less, transmitter means to said paired receiver means;
and wherein said receiver means utilizes said digital intensity level for any purpose such as the action of affecting the timing of a conduction cycle of a solid state switch known as a TRIAC device means, and in conjunction with a zero crossing detector device means, controls the conduction cycle duration of said TRIAC device means, but not limited to only a TRIAC device means;
and wherein said received random number generated key code is a stored member in a receiver key code non-volatile memory stack of a plurality of key codes;
and wherein said plurality of received key codes reaches a number beyond the limit of said plurality number, any additional incoming received key codes are ignored;
and wherein there remains said continuous monitoring and interrogation of said receiver status for any and all future incoming received data transmissions for key code valid entries from a paired battery-less and wireless, but not limited to a battery-less, transmitter or plurality of paired battery-less and wireless, but not limited to battery-less, transmitters during and after an ON or OFF or any intensity level condition in said paired receiver device means;
and wherein said key code generated is moved to a queue register for transmission and all data is transmitted and then said transmitter algorithm is terminated until a future control flick from said disposed energy harvesting generator disposed within said battery-less and wireless, but not limited to a battery-less, transmitter creates a new burst of electrical power and said stated sequence starts all over again;

2. Another embodiment of a plurality of logic algorithms comprising:
a set of algorithms for utilization in another embodiment of said present invention of a battery-less and wireless transmitter and a remote receiver system that is paired together and matches to a specific internally generated random number key code or plurality of key codes, but not limited to a random number generated key code or plurality of key codes, and can be paired and matched by other forms of key code or plurality of key codes generation;
and whereby said key code that is generated by said transmitter algorithms is stored for any future use;
and when said key code or plurality of key codes are generated, said key code generator will be disabled from generating any future key codes that would be evaluated as an interference with said uniqueness of said specific generated key code or plurality of key codes;
and wherein in another embodiment of said present invention, said transmitter algorithm executes an interrogation algorithm that monitors and interrogates for a switch position result, from said disposed selection switch within said battery-less and wireless, but not limited to a battery-less, transmitter that determines whether said disposed selection switch is in a user selected ON/OFF mode or in an AUTO DIM mode;
and wherein if said selector switch is moved into its ON/OFF position, said key code generated is moved to a queue register for transmission and all data is transmitted and then said transmitter algorithm is terminated until a future control flick from said disposed energy harvesting generator disposed within said battery-less and wireless, but not limited to a battery-less, transmitter creates a new burst of electrical power and said stated sequence starts all over again;
and wherein if said selector switch is moved into its AUTO DIM position, said key code that was generated has a logic “1” placed by action of the hard wired effect of a switch terminal yielding a logic “1” in the Most Significant Bit of the key code information byte, but not limited to a Most Significant Bit, thus changing the key code to a new key code value that now represents a DIM command in a remote paired receiver system, and said new key code is transmitted and said algorithm is terminated until a future control flick from said disposed energy harvesting generator disposed within said battery-less and wireless, but not limited to a battery-less, transmitter creates a new burst of electrical power and said stated sequence starts all over again.

3. Another embodiment of a plurality of logic algorithms comprising:
Another embodiment of said present invention wherein a plurality of receiver algorithms dedicated to creating a paired receiver that utilizes a dual function of switching and dimming an electrical load;
and wherein said paired receiver accepts a key code or a plurality of key codes sent from a paired remote battery-less and wireless, but not limited to a battery-less, transmitter;
and wherein said received key code is stored in said paired receiver and used to control a TRIAC solid state switch, but not limited to a TRIAC solid state switch, to turn on and off an electrical load under the electrical influence of said receiver's control function;
and wherein said received originally generated device matching key code is altered in value by said remote paired battery-less and wireless, but not limited to a battery-less, transmitter and said altered value key code is utilized by said paired receiver in conjunction with a zero crossing detector in communication with the AC power mains;
and wherein if said selector switch is moved into its AUTO DIM position, said key code that was generated has a logic “1” placed by action of the hard wired effect of a switch terminal yielding a logic “1” in the Most Significant Bit of the key code information byte, but not limited to a Most Significant Bit, thus changing the key code to a new key code value that now represents a DIM command in a remote paired receiver system, and said new key code is transmitted and said algorithm is terminated until a future control flick from said disposed energy harvesting generator disposed within said battery-less and wireless, but not limited to a battery-less, transmitter creates a new burst of electrical power and said stated sequence starts all over again and wherein said combination of said altered key code and resultant electrical pulse from the output of said zero crossing detector, is temporarily stored and utilized to create a timer start and stop pulse that controls a start timer internal to a disposed receiver microcontroller that further starts an intensity level timer to slowly undulate a DIM value for said electrical load.

4. An algorithm as recited in claim 1, wherein said algorithm or plurality of algorithm instructions are disposed within a solid state non-volatile memory and components of said instructions and results of calculation are disposed in either volatile or non-volatile memory;
and wherein all algorithm instructions are executed by a microcontroller means controlling transmissions from a battery-less and wireless, but not limited to a battery-less, transmitter means that is paired with a remote paired receiver system means.

5. An algorithm as recited in claim 3, wherein said algorithm or plurality of algorithm instructions are disposed within a solid state non-volatile memory and components of said instructions and results of calculation are disposed in either volatile or non-volatile memory;
and wherein all algorithm instructions are executed by a microcontroller means controlling transmissions from a battery-less and wireless, but not limited to a battery-less, transmitter means that is paired with a remote paired receiver system means.

6. An algorithm as recited in claim 2, wherein said algorithm or plurality of algorithm instructions are disposed within a solid state non-volatile memory and components of said instructions and results of calculation are disposed in either volatile or non-volatile memory;
and wherein all algorithm instructions are executed by a microcontroller means controlling reception from a receiver means that is paired with a remote paired battery-less and wireless, but not limited to a battery-less, transmitter system means.

7. An algorithm as recited in claim 4, wherein said algorithm or plurality of algorithm instructions are disposed within a solid state non-volatile memory and components of said instructions and results of calculation are disposed in either volatile or non-volatile memory;
and wherein all algorithm instructions are executed by a microcontroller means controlling reception from a receiver means that is paired with a remote paired battery-less and wireless, but not limited to a battery-less, transmitter system means.

8. An algorithm as recited in claim 1, wherein said algorithm can be expanded in its instruction set to include additional functional control features for digital signal processed audio and video signal transmissions or any digital signal processed data transmissions.

9. An algorithm as recited in claim 3, wherein said algorithm can be expanded in its instruction set to include additional functional control features for digital signal processed audio and video signal transmissions or any digital signal processed data transmissions.

10. An algorithm as recited in claim 2, wherein said algorithm can be expanded in its instruction set to include additional functional control features for digital signal processed audio and video signal reception or any digital signal processed data reception.

11. An algorithm as recited in claim 4, wherein said algorithm can be expanded in its instruction set to include additional functional control features for digital signal processed audio and video signal reception or any digital signal processed data reception.

12. An algorithm as recited in claim 1, wherein said algorithm is modified to be in transmission and reception with a plurality of transceiver relay stations for the purpose of extending the range of a battery-less and wireless transceiver system means.

13. An algorithm as recited in claim 2, wherein said algorithm is modified to be in transmission and reception with a plurality of transceiver relay stations for the purpose of extending the range of a battery-less and wireless transceiver system means.

14. An algorithm as recited in claim 3, wherein said algorithm is modified to be in transmission and reception with a plurality of transceiver relay stations for the purpose of extending the range of a battery-less and wireless transceiver system means.

15. An algorithm as recited in claim 4, wherein said algorithm is modified to be in transmission and reception with a plurality of transceiver relay stations for the purpose of extending the range of a battery-less and wireless transceiver system means.
